(19) United States
(12) Patent Application Publication
(10) Pub. No.: US 2020/0370501 A1
(43) Pub. Date: Nov. 26, 2020

(54) INTAKE PORTS FOR A DIESEL ENGINE

(71) Applicant: GM Global Technology Operations LLC, Detroit, MI (US)

(72) Inventors: Alberto Lorenzo Vassallo, Torino (IT); Jian Gao, Auburn Hills, MI (US)

(21) Appl. No.: 16/418,566

(22) Filed: May 21, 2019

(51) Int. Cl. F02F 1/42; F02M 35/108

(52) U.S. Cl. CPC F02F 1/425; F02B 2031/006; F02M 35/1085

(57) ABSTRACT

An apparatus that controls a swirl ratio in a diesel engine for a motor vehicle includes a first intake port that directs a first airflow into a combustion chamber, and a second intake port that directs a second airflow into the combustion chamber. The first and second intake ports are arranged to direct the first airflow and the second airflow such that a desired swirl ratio is achieved in the combustion chamber.

The present disclosure relates to intake ports. More specifically, the present disclosure relates to intake ports for a diesel engine.

In a typical diesel engine for a motor vehicle, the engine includes multiple combustion chambers in which air and fuel are mixed and combustion occurs from the compression of the air and fuel mixture. Generally, one or more intake ports directs airflow into the combustion chamber. As the air flows into the combustion chamber from the intake ports, a swirl flow pattern of the airflow is generated in the combustion chamber. Such swirl flow patterns result in higher temperature gradients and heat flux during the combustion process, which increases heat loss and reduces the efficiency of the diesel engine.

Thus, while current diesel engines achieve their intended purpose, there is a need for a new and improved system to direct airflow into the diesel engine to reduce heat loss from the engine, thereby increasing the efficiency of the engine.

### SUMMARY

According to several aspects, an apparatus that controls a swirl ratio in a diesel engine for a motor vehicle includes a first intake port that directs a first airflow into a combustion chamber, and a second intake port that directs a second airflow into the combustion chamber. The first and second intake ports are arranged to direct the first airflow and the second airflow such that a desired swirl ratio is achieved in the combustion chamber.

In an additional aspect of the present disclosure, the first airflow is a tangential airflow in a first direction.

In another aspect of the present disclosure, the second airflow is a tangential airflow in a second direction.

In another aspect of the present disclosure, the second direction is an opposing direction to the first direction.

In another aspect of the present disclosure, the first and second intake ports are rotated about respective axes to arrange the first and second intake ports.

In another aspect of the present disclosure, the first intake port includes a first swirl valve that controls a flowrate of the first airflow from the first intake port into the combustion chamber.

In another aspect of the present disclosure, the second intake port includes a second swirl valve that controls a flowrate of the second airflow from the second intake port into the combustion chamber.

In another aspect of the present disclosure, the swirl ratio has a range between about 0 and 2.5.

In another aspect of the present disclosure, the swirl ratio is about 0.

According to several aspects, an apparatus that controls a swirl ratio in a diesel engine for a motor vehicle includes a first intake port that directs a first airflow into a combustion chamber, the first airflow being a tangential airflow in a first direction, and a second intake port that directs a second airflow into the combustion chamber, the second airflow being a tangential airflow in a second direction, the second direction being an opposing direction to the first direction. The first and second intake ports are arranged to direct the first airflow and the second airflow such that a desired swirl ratio is achieved in the combustion chamber.

In another aspect of the present disclosure, the first and second intake ports are rotated about respective axes to arrange the first and second intake ports.

In another aspect of the present disclosure, the first intake port includes a first swirl valve that controls a flowrate of the first airflow from the first intake port into the combustion chamber.

In another aspect of the present disclosure, the second intake port includes a second swirl valve that controls a flowrate of the second airflow from the second intake port into the combustion chamber.

In another aspect of the present disclosure, the swirl ratio has a range between about 0 and 2.5.

In another aspect of the present disclosure, the swirl ratio is about 0.

According to several aspects, a diesel engine for a motor vehicle includes a first intake port that directs a first airflow into a combustion chamber, the first intake port including a first swirl valve that controls a flowrate of the first airflow from the first intake port into the combustion chamber, the first airflow being a tangential airflow in a first direction; and a second intake port that directs a second airflow into the combustion chamber, the second intake port including a second swirl valve that controls a flowrate of the second airflow from the second intake port into the combustion chamber, the second airflow being a tangential airflow in a second direction. The first and second intake ports are arranged to direct the first airflow and the second airflow such that a desired swirl ratio is achieved in the combustion chamber.

In another aspect of the present disclosure, the second direction is an opposing direction to the first direction.

In another aspect of the present disclosure, the first and second intake ports are rotated about respective axes to arrange the first and second intake ports.

In another aspect of the present disclosure, the swirl ratio has a range between about 0 and 2.5.

In another aspect of the present disclosure, the swirl ratio is about 0.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 shows a pair of tangential intake ports for a diesel engine in accordance with the present disclosure;

FIG. 2 shows a helical intake port and a tangential intake port for a diesel engine;

FIG. 3 is a graph showing a comparison of the swirl ratio for the intake ports shown in FIG. 1 and the intake ports shown in FIG. 2;

FIG. 4 is a perspective view of a pair of intake ports with swirl valves in accordance with the present disclosure;

FIG. 5 is a close-up view of a swirl valve for an intake port in accordance with the present disclosure; and

FIG. 6 is a graph showing the swirl ratio vs the swirl valve position.

### DETAILED DESCRIPTION

The following description is merely exemplary in nature and is not intended to limit the present disclosure, application, or uses.

Referring to FIG. 1, there is shown a portion of a diesel engine 10 in accordance with the principles of the present disclosure. The portion of the diesel engine 10 includes a combustion chamber with a cylinder head 12. The cylinder head 12 communicates with a pair of exhaust ports 14 and 16 and a pair of intake ports 18 and 20. The intake ports 18 and 20 are arranged to provide a region 19 in the cylinder head 12 that adapts to various packaging constraints such as, for example, bolts, water jackets and/or glow plugs.

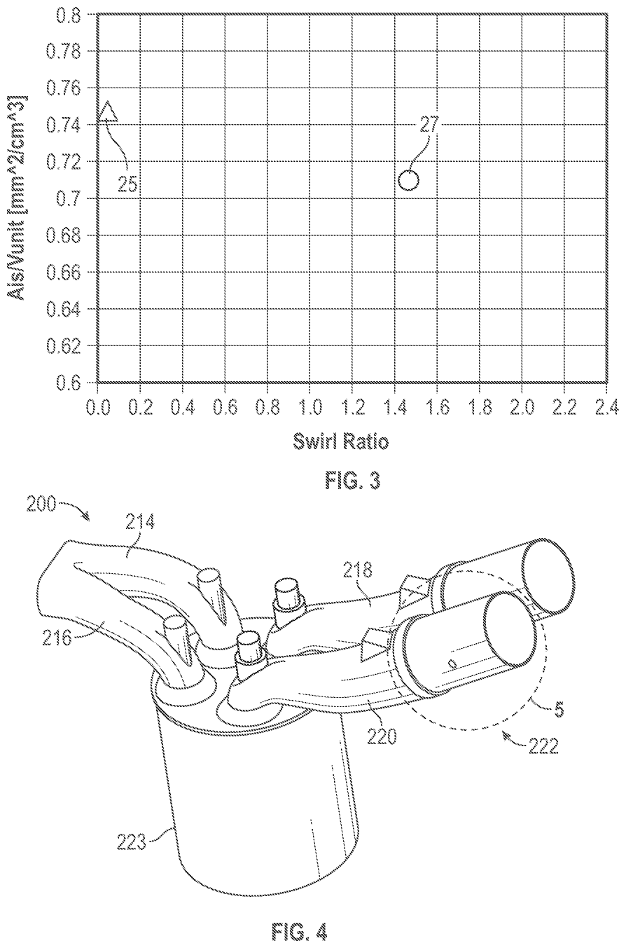

The intake port 18 directs an airflow into the combustion chamber through the cylinder head 12, and the intake port 20 also directs an airflow into the combustion chamber through the cylinder head 12 as well. The intake ports 18 and 20 are arranged to direct the two airflows to achieve a desired swirl ratio in the combustion chamber. For example, in certain arrangements, the intake port 18 directs a tangential airflow, that is, tangentially to the interior surface of the combustion chamber in one direction, while the intake port 20 also directs a tangential airflow into the combustion chamber. By rotating the intake port 18 about the axis 21 and the intake port 20 about the axis 23, where the axes 21 and 23 extend out of the page as shown in FIG. 1, a desired swirl ratio is achieved. For example, if the intake port 18 directs the respective airflow in one tangential direction and the intake port 20 directs an equal and opposing tangential airflow, then a swirl ratio of about zero is achieved, as indicated by the data point 25 in the graph shown in FIG. 3. If instead both intake ports 18 and 20 direct tangential airflow in the same direction, then a swirl ratio of about 1.5 is achieved, as indicated by the data point 27 in the graph shown in FIG. 3. At the same time, the data points 25 and 27 exhibit other effects of the ports rotation, which is the capability to improve the volumetric efficiency in the case of low swirl ratio achievement (high value for Ais/Vunit, representing the isoentropic area achieved per unit displacement). The well in FIG. 3 illustrates how easily a wide variation of the overall swirl level is achieved, combined with excellent flowage, with a simple rotation of the intake ports and without the need to modify the port shape, which represents a particular advantage of the present disclosure.

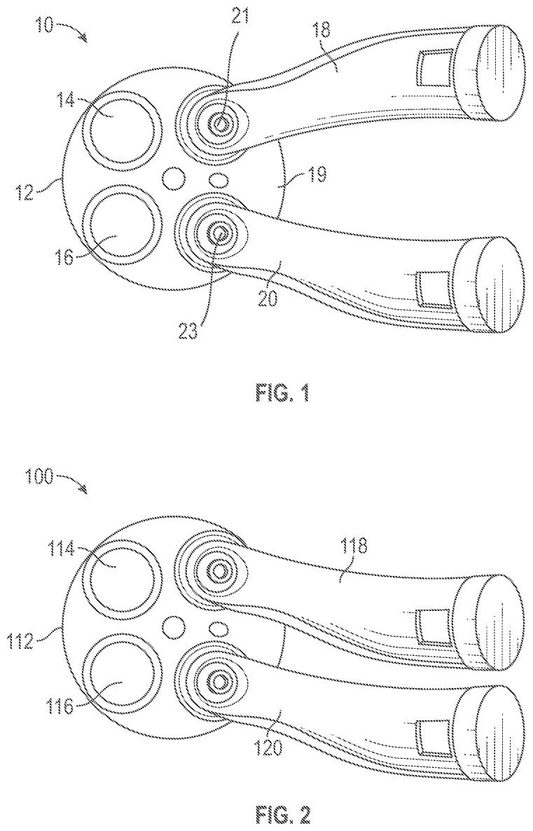

In contrast to the arrangement shown in FIG. 1, FIG. 2 shows a portion of a diesel engine 100 with a cylinder head 112. The cylinder head 112 communicates with a pair of exhaust ports 114 and 116 and a pair of intake ports 118 and 120 that both direct tangential airflow in the same direction. As such, the arrangement of the intake ports 118 and 120 result in a swirl ratio greater than zero as indicated by the data point 27 in FIG. 3. Further note that the arrangement of the intake ports 118 and 120 provide less area between the intake ports 118 and 120 than the region 19 between the intake ports 18 and 20 for adaptation to various packaging constraints such as, for example, bolts, water jackets and/or glow plugs.

Turning now to FIG. 4, there is shown an alternative portion of a diesel engine 200 with a combustion chamber 223. A pair of exhaust ports 214 and 216 as well as a pair of intake ports 218 and 220 communicate with the combustion chamber 223. The arrangement for the intake ports 218 and 220 is similar to that shown if FIG. 1 with the intake ports 218 and 220 providing opposing tangential airflow into the combustion chamber 223.

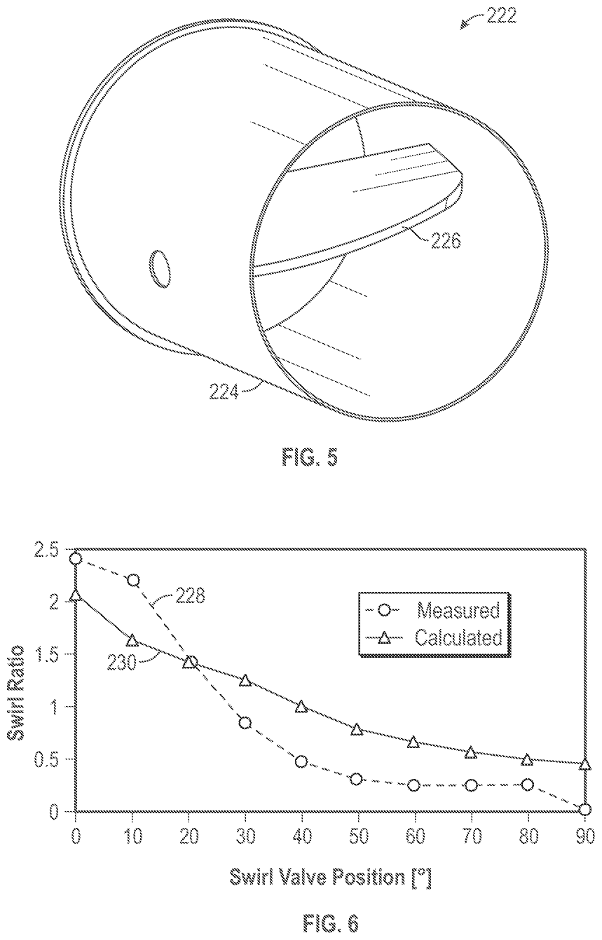

In various arrangements, one or both intake ports 218 and 220 includes a swirl valve 222 shown in FIG. 5. The swirl valve 222 includes a housing 224 with a flap 226 that is able to rotate within the housing 224. As such, when the swirl valve 222 is fully open, the flap 226 is in a 90° position, and when the swirl valve is fully closed, the flap 226 is in a 0° position. Hence, when the swirl valve 222 is fully open, there is no restriction to the airflow through the respective intake port 218 or 220. And when the swirl valve is fully closed, the airflow through the respective intake port 218 or 220 is shut off. Accordingly, by varying the position of the flap 226 in one of the intake ports 218 and 220, the airflow to the combustion chamber 223 is controlled.

The swirl ratio in the combustion chamber 223 versus the swirl valve position for a swirl valve 222 implemented in the intake port 220 for both numerically calculated 230 and experimentally measured 228 values is exhibited in the graph shown in FIG. 6. Specifically, when the swirl valve 222 shuts off (the flap is in the 0° position) the air flow through the intake port 220, the arrangement shown in FIG. 4 provides a swirl ratio of about 2, since all the airflow into the combustion chamber 223 comes from the intake port 218, and when the swirl valve 222 is fully open (the flap is in the 90° position), the arrangement shown in FIG. 4 provides a swirl ratio near zero. Note that the utilization of the swirl valve 222 is not limited to the arrangement of intake valve that provide opposing tangential airflow. For example, in some arrangements, the swirl valve 222 is implemented in the arrangement shown in FIG. 2.

Intake ports for diesel engines according to present disclosure offers several advantages. These include providing a larger region on the cylinder head for various packaging constraints such as, for example, bolts, water jackets and/or glow plugs. Further, such intake ports, enable an efficient arrangement to obtain any desired swirl ratio with a combustion chamber of a diesel engine.

In the claims and specification, certain elements are designated as “first” and “second”. These are arbitrary designations intended to be consistent only in the section in which they appear, i.e. the specification or the claims or the summary, and are not necessarily consistent between the specification, the claims, and the summary. In that sense they are not intended to limit the elements in any way and a “second” element labeled as such in the claim may or may not refer to a “second” element labeled as such in the specification. Instead, the elements are distinguishable by their disposition, description, connections, and function.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. An apparatus that controls a swirl ratio in a diesel engine for a motor vehicle, the apparatus comprising:
a first intake port that directs a first airflow into a combustion chamber; and
a second intake port that directs a second airflow into the combustion chamber,
the first and second intake ports being arranged to direct the first airflow and the second airflow such that a desired swirl ratio is achieved in the combustion chamber.

2. The apparatus of claim 1, wherein the first airflow is a tangential airflow in a first direction.

3. The apparatus of claim 2, wherein the second airflow is a tangential airflow in a second direction.

4. The apparatus of claim 2, wherein the second direction is an opposing direction to the first direction.

5. The apparatus of claim 1, wherein the first and second intake ports are rotated about respective axes to arrange the first and second intake ports.

6. The apparatus of claim 1, wherein the first intake port includes a first swirl valve that controls a flowrate of the first airflow from the first intake port into the combustion chamber.

7. The apparatus of claim 6, wherein the second intake port includes a second swirl valve that controls a flowrate of the second airflow from the second intake port into the combustion chamber.

8. The apparatus of claim 1, wherein the swirl ratio has a range between about 0 and 2.5.

9. The apparatus of claim 8, wherein the swirl ratio is about 0.

10. An apparatus that controls a swirl ratio in a diesel engine for a motor vehicle, the apparatus comprising:
a first intake port that directs a first airflow into a combustion chamber, the first airflow being a tangential airflow in a first direction; and
a second intake port that directs a second airflow into the combustion chamber, the second airflow being a tangential airflow in a second direction, the second direction being an opposing direction to the first direction,
the first and second intake ports being arranged to direct the first airflow and the second airflow such that a desired swirl ratio is achieved in the combustion chamber.

11. The apparatus of claim 10, wherein the first and second intake ports are rotated about respective axes to arrange the first and second intake ports.

12. The apparatus of claim 10, wherein the first intake port includes a first swirl valve that controls a flowrate of the first airflow from the first intake port into the combustion chamber.

13. The apparatus of claim 12, wherein the second intake port includes a second swirl valve that controls a flowrate of the second airflow from the second intake port into the combustion chamber.

14. The apparatus of claim 1, wherein the swirl ratio has a range between about 0 and 2.5.

15. The apparatus of claim 14, wherein the swirl ratio is about 0.

16. A diesel engine for a motor vehicle, the diesel engine comprising:
a first intake port that directs a first airflow into a combustion chamber, the first intake port including a first swirl valve that controls a flowrate of the first airflow from the first intake port into the combustion chamber, the first airflow being a tangential airflow in a first direction; and
a second intake port that directs a second airflow into the combustion chamber, the second intake port including a second swirl valve that controls a flow rate of the second airflow from the second intake port into the combustion chamber, the second airflow being a tangential airflow in a second direction,
the first and second intake ports being arranged to direct the first airflow and the second airflow such that a desired swirl ratio is achieved in the combustion chamber.

17. The diesel engine of claim 16, wherein the second direction is an opposing direction to the first direction.

18. The diesel engine of claim 16, wherein the first and second intake ports are rotated about respective axes to arrange the first and second intake ports.

19. The diesel engine of claim 16, wherein the swirl ratio has a range between about 0 and 2.5.

20. The diesel engine of claim 19, wherein the swirl ratio is about 0.
